(19) United States
(12) Patent Application Publication
(10) Pub. No.: US 2025/0139534 A1
(43) Pub. Date: May 1, 2025

(54) Accurately-Diverse Ensembles: A New Technique for Unsupervised Validation of Anomaly-Detection Models

(71) Applicant: Lihi IDAN, Providence, RI (US)

(72) Inventor: Lihi IDAN, Providence, RI (US)

(21) Appl. No.: 18/496,873

(22) Filed: Oct. 29, 2023

(51) Int. Cl. G06N 20/20

(52) U.S. Cl. CPC G06N 20/20

(57) ABSTRACT

Unsupervised anomaly detection is a highly challenging task. While there exists a large body of work that aims at addressing that challenge, the vast majority of prior works focus on developing new unsupervised anomaly-detection models; other components of the unsupervised anomaly-detection pipeline such as model selection and model evaluation remain severely under-researched despite their tremendous importance for receiving valid and generalizable results. This invention aims at filling this gap by introducing the Accurately-Diverse Ensemble: an ensemble of heterogeneous, unsupervised anomaly-detection models built using the key idea that in order to balance accuracy and diversity, the ensemble's decisions must exhibit both heterogeneity and homogeneity in a complementary manner. Using extensive experimental results we show that (1) an Accurately-Diverse ensemble outperforms the average anomaly-detection model thus eliminating the need for a model-selection procedure and (2) an Accurately-Diverse ensemble can be used to evaluate any anomaly-detection model in an unsupervised manner, yielding results that are on par with those of supervised evaluation metrics.

### BACKGROUND OF THE INVENTION

Anomaly detection (AD) is the task of identifying the minority of data observations that deviate significantly from the majority of the observations. Anomaly detection is an extremely common and important task used in numerous domains; examples include the financial domain, in which anomaly-detection algorithms are used to identify fraudulent activity [16,23]; the medical domain, in which anomaly-detection algorithms are used to discover rare diseases [12,31]; in the cybersecurity domain, in which anomaly-detection algorithms are used to discover malicious network activity [3, 13]; etc. From a machine-learning point of view, the goal of anomaly-detection tasks is classifying observations as either inliers or outliers; thus, anomaly-detection tasks are oftentimes treated as classification tasks where the positive class denotes the anomalous class. However, anomaly-detection tasks are significantly more challenging than standard classification tasks: first, anomaly-detection tasks are extremely imbalanced as the number of outliers is significantly smaller than the number of inliers. Second, unlike standard classification tasks where equal importance is given to all types of errors, in anomaly-detection tasks certain types of errors are significantly more important than others, thus minimizing those types of errors is the most important, sometimes the only, goal of the model. Third, the definition of an “anomaly” in the context of a specific dataset can be ambiguous if the traits that make an observation an outlier are subjective; in such cases, the notion of an “outlier” is not well defined. While anomaly-detection tasks are challenging, they can be well-managed when the underlying datasets are labeled. In such cases, training can be done using either supervised or semi-supervised models; the best model (i.e. model selection) can be chosen using a labeled validation set, and the performance of the chosen model can be assessed (i.e. model evaluation) using a (second) labeled validation set. The above no longer holds when the anomaly-detection task at hand is unsupervised and labeled datasets are not available. Though the pool of unsupervised anomaly-detection models has been steadily increasing over the past few years thus reducing the requirement of labeled training sets, two acute challenges remain when labeled data is not available: unsupervised model selection and unsupervised model evaluation. Due to the lack of a labeled validation set, standard validation and evaluation practices cannot be applied, while research on methods that do not require a labeled validation set is surprisingly scarce. Hence, there is a pressing need for techniques that enable model selection and evaluation of anomaly-detection models in an unsupervised setting, when no labeled data is available. In this invention, we aim at filling this gap by introducing a new approach to model selection and evaluation of anomaly-detection models which does not require any labeled data.

Prior work: As the limitations of unsupervised anomaly detection have been widely acknowledged, there have been multiple recent attempts for designing more effective unsupervised anomaly detection models: probabilistic methods such as [17, 18], neural-network-based methods such as [19, 27, 32] and even graph-based methods such as [9]. Works such as [8, 10] aim at benchmarking the most prominent unsupervised anomaly-detection models as well as creating general rules of thumb on the best settings for using each model based on different criteria such as the dataset's domain and quality.

The use of ensembles for anomaly detection has been explored in multiple works. Yet, those works significantly differ from ours: either they assume a supervised or a semi-supervised setting where labels are available [30, 33]; use ensembles based on feature diversification [14, 22], or use homogeneous ensembles [2, 11, 25, 34].

The research on unsupervised evaluation methods of anomaly-detection models has been surprisingly scarce. The only two well-grounded, fully unsupervised evaluation methods that we are aware of are the method described in [20], based on soft-margin classifiers, and the method described in [6], based on excess mass and mass volume curves. All other methods that we are aware of, such as the p-value-based evaluation method in [1], require a labeled validation set.

### BRIEF SUMMARY OF THE INVENTION

Our approach is based on the following key ideas:
1. In cases where the ground truth is not available, a representative majority's opinion is a good-enough approximator for the ground truth.
2. One way to obtain a representative majority's opinion is building an Accurately-Diverse ensemble: an ensemble of unsupervised models that sufficiently balances the ensemble's accuracy and diversity.
3. In order for an ensemble to be Accurately-Diverse, the ensemble's decisions must exhibit both heterogeneity and homogeneity in a complementary manner: we require a strong intra-ensemble agreement on the general trend of each ensemble member's predictions, while encouraging a strong intra-ensemble disagreement on the exact ordering of each ensemble member's predictions.
4. The exact ordering of a model's predictions is approximated by the ranked anomaly-score indices of the least distinctive observations in the dataset: non-extreme inliers. The general trend of a model's predictions is approximated by its “fuzzy ranks”: ranked anomaly-score clusters of the most distinctive observations in the dataset: strong outliers. The level of agreement among ensemble members is approximated using a rank correlation metric, computed separately on fuzzy ranks of strong outliers and on exact ranks of non-extreme inliers.
5. The rank correlation metric should be carefully designed so that it can both be applied to M>2 lists, and so that it can account for the unique structure of anomaly score lists compared to other general-purpose ranked lists. We design multiple multi-way correlation metrics that are specifically suited to measuring the correlation among ranked anomaly scores.

The intuition that is being captured through this mechanism is simple: the fact that anomalies are, by definition, both uncommon and extreme in values makes their identification a task that coincides with an “absolute truth”—one that is both general and unequivocal and thus should be captured by any qualified enough model given an adequate amount of high-quality data. The exact scores given to inliers, on the other hand, do not coincide with any absolute truth; in fact, such a decision is an inherently subjective decision. The exact scores given to inliers thus represent the peculiarities of the decision boundary resulting from the model's individual judgment based on the unique traits of the model's discriminant function. To assess the performance of an anomaly-detection ensemble without access to any labeled data, we approximate the extent to which it balances accuracy and diversity by requiring that the ensemble is composed of models whose decision-boundary shape is similar enough, thus accurately capturing the ground truth (a notion approximated by a high correlation on fuzzy rank positions of strong outliers), but that do so because they deduced this truth using different mechanisms—and thus we can be more confident on the aggregated decision—rather than because they simply represent the exact same discriminant function (a notion approximated by low correlation on exact rank positions of non-extreme inliers).

We use the Accurately-Diverse ensemble to address the two main challenges in unsupervised anomaly detection:
1. Unsupervised model selection: we show that an Accurately-Diverse ensemble yields better results than the average anomaly-detection model on unsupervised anomaly-detection tasks; thus, using the Accurately-Diverse ensemble eliminates the need for a model-selection procedure.
2. Unsupervised model evaluation: an Accurately-Diverse ensemble can be used to evaluate other anomaly-detection models in an unsupervised manner, yielding results that are on par with those of supervised evaluation metrics.

### DETAILED DESCRIPTION OF THE INVENTION

### 1 The Diversity-Accuracy Tradeoff as a Proxy of Ensembles' Representativeness

The following procedure can be used for unsupervised anomaly-detection evaluation: choose a large number of better-than-random models, and query each one for whether an observation is an anomaly or not; choosing a large-enough number of models and aggregating their predictions using a carefully-designed aggregation method based on the majority vote will provide us with the correct label of each observation.

Practically speaking, however, we are limited in the number of models that can be queried; furthermore, it is not immediately clear how much is “large enough”. We, therefore, need to come up with a metric that will approximate the notion of “large enough”: that is, a methodology to choose M models that are representative enough so that they adequately approximate the output of a “large-enough” set of models, where we assume M to be a relatively small number.

### 1.1 A Motivating Example: Judicial Diversity

Over recent years, the importance of judicial diversity has been widely acknowledged. Research shows that judicial diversity ensures that judicial decisions reflect a broad set of viewpoints, values, and belief systems.

How should judicial diversity be quantified? the most common metric used nowadays for measuring judicial diversity is the heterogeneity level of judges' demographic attributes. The implicit assumption behind this metric is the existence of a causal relation between demographic attributes and judicial decisions. Hence, the natural outcome of diversifying demographic attributes among judges is a diversification of the decisions being made. Another method that has been proposed, the “evidence-based” method [4], ignores the causal relation between demographic attributes and judicial decisions, and instead solely examines the decisions being made by the ensemble. Generally speaking, when analyzing a series of decisions made by an ensemble of M judges we would expect that, if the judges indeed are diverse enough, at least some of their decisions will exhibit a certain degree of heterogeneity.

But is diversity sufficient for making high-quality decisions? what if the individual decisions are “too” diverse so that the ensemble members are never able to reach a decision? what if the decisions are diverse, but when combined together, the decision is simply wrong? the key idea is that we want the ensemble members' decisions to exhibit just the right degree of heterogeneity: we expect different judges to make different decisions, but only when those differences contribute to the final aggregated decision of the ensemble.

We can break down the ideas articulated in the prior paragraphs into the following three statements, inspired by the ideas given in [4]:
1. The ensemble members should hold heterogeneous opinions: judges should hold different opinions on different matters and should thus make different decisions on at least some cases that are being judged.
2. The ensemble members should hold similar opinions on distinctive cases: while heterogeneity of opinions is a highly desired property of an ensemble, we would still expect that, if the ensemble is valid, its members will hold similar opinions on either highly important or highly extreme matters. That is, the individual ensemble members' diversity is such that allows them to hold different points of view on different matters that can be ambiguous or open to different interpretations; yet for those matters that their importance or extremeness is so high to the extent that it reflects an absolute truth that rises above any personal belief system, we would expect the ensemble members to be stable enough to hold similar opinions and thus reach the decision that coincides with the absolute truth.
3. Independence of errors: we acknowledge that individual ensemble members will occasionally make wrong decisions; we expect the ensemble to balance the errors of its members so that its members are not consistently making similar errors.

Note that there exists an inherent tradeoff between the three statements above which results from the inherent tension between heterogeneity and homogeneity as well as between accuracy and diversity. One possible way to accommodate those seemingly contradictory statements is analyzing case-specific instantiations of those general statements: for instance, are there specific conditions under which homogeneity and heterogeneity are not mutually exclusive?

### 1.2 An Accurately-Diverse Ensemble: Definition

The diversity-accuracy tradeoff is an inherent challenge in ensemble-based approaches. In unsupervised settings, it becomes an even bigger challenge since the common practices for testing the accuracy of a model such as using a labeled validation set can not be applied. Our assumption is that when evaluating our ensemble, we do not have access to any source of “ground truth”. We, therefore, need to design a metric that will enable us to assess both the accuracy and diversity of an ensemble without any access to labels.

Our core idea used for designing such a metric is inspired by the ideas presented in Subsection 1.1, which lists 3 requirements from a judicial ensemble: opinion heterogeneity, opinion homogeneity, and independence of errors. At first glance it is unclear how a single unsupervised ensemble can meet all three requirements: first, opinion homogeneity and heterogeneity, as well as opinion homogeneity and independence of errors, seem to be mutually exclusive. Second, in order to evaluate the independence-of-errors requirement we must have access to the ground truth of a subset of observations so we can determine which predictions were “mistakes”. This requirement cannot be accommodated in the unsupervised case. Nevertheless, we claim that an unsupervised ensemble that meets all three requirements not only exists, but can also be easily identified using the following key observation:
In order to balance accuracy and diversity, the ensemble's decisions must exhibit both heterogeneity and homogeneity in a complementary manner that highlights the general, common shape of the ensemble member's decision boundary and at the same time blurs their individual peculiarities. This conceptual observation can be practically approximated by requiring a strong intra-ensemble agreement on the general trend of each member's predicted anomaly scores, while encouraging a strong intra-ensemble disagreement on the exact ordering of each member's predicted scores. In such a case, the individual errors of the ensemble members will be sufficiently independent so that the aggregated decision coincides with the ground truth. We refer to such an ensemble as an Accurately-Diverse ensemble.

Specifically, in order for an ensemble to be Accurately-Diverse, two conditions must hold:
(1) The ensemble members should strongly agree on high-level features of highly-distinctive observations in the dataset.
(2) The ensemble members should strongly disagree on low-level features of lowly-distinctive observations in the dataset.

The main claims that are at the core of this invention are the following:
1. In unsupervised anomaly-detection settings where a supervised model-selection procedure—a procedure that compares the performance of N candidate anomaly-detection models on a given dataset—cannot be performed due to the lack of labeled data, an Accurately Diverse ensemble will yield better results than the average anomaly-detection model thus eliminating the need for a model-selection procedure.
2. In unsupervised anomaly-detection settings, where the only model that can be used is a single model rather than an ensemble (for instance, due to regulatory requirements) yet due to the lack of a labeled validation set a supervised evaluation of the model cannot be performed, an Accurately-Diverse ensemble can be used to evaluate the model's predictions in an unsupervised manner, yielding results that are on par with those of supervised evaluation metrics.

Combining the above claims, once we have built an Accurately-Diverse ensemble we can use it in two ways: first, we can use it as our unsupervised anomaly-detection model. For this purpose, we need a procedure for combining the outputs of each of the ensemble's base models to produce the final score of each observation in the dataset. In the next sections, we discuss multiple options for implementing such a procedure as well as explain our approach to building an Accurately-Diverse ensemble. Second, we can use the ensemble to evaluate other anomaly-detection models in an unsupervised manner, as shown in Algorithm 4. In Section 4, we present our experimental results when comparing our ensemble-based evaluation metric to other supervised metrics.

### 2 Accurately Diverse Ensembles

### 2.1 Distinctive Observations

There are multiple ways to define which observations in a dataset are distinctive. As we work in an anomaly-detection setting, in which anomalous observations are both rare, most extreme in values, and result in the highest penalty in case they were not correctly classified, the distinctiveness level of a case in the dataset will correspond to its anomaly score. We define highly distinctive observations as follows:

A highly distinctive observation: an observation to which at least one ensemble member gave a high anomaly score.

When measuring the distinctiveness level of an observation as a function of its anomaly score, a natural definition of lowly-distinctive observations will be the following:

A lowly-distinctive observation: an observation to which none of the ensemble members gave a high anomaly score.

Indeed, our first experiments were conducted under the above definition of lowly-distinctive observations. However, when utilizing the above definition we have found the results to be unsatisfactory. Specifically, on some types of datasets, the correlation between the ensemble's performance, and low correlation on lowly-distinctive observations, was not significant. When analyzing the results, we have noticed that those unsatisfactory results are obtained on datasets of a very specific type, which we refer to as “synthetic” anomaly-detection datasets: most of the publicly-available anomaly-detection datasets were not originally created to capture a true anomaly-detection setting, in which most observations represent a normal behavior and the minority of the observations represent an abnormal behavior but are rather “synthetic” anomaly-detection datasets which are standard multi-way classification datasets where some of the minority classes were merged to form the outlier class and some of the majority classes were merged to form the inlier class. An example of a non-synthetic anomaly-detection dataset is “fraud”: the vast majority of the datasets' observations represent normal transactions while a very small minority represents fraudulent transactions. The key observation is that in non-synthetic anomaly-detection datasets, only the outlier class has “well-defined” characteristics. This is as opposed to synthetic anomaly-detection datasets, for instance, datasets that contain images of digits, in which some of the rare digits are merged together to form the minority class, and the rest of the digits are merged to form the majority class. In such a case, the inlier class also has well-defined characteristics: inliers that look the most like each of the digits that were synthetically chosen to populate the majority class.

Based on our analysis, we hypothesized that the reason for the unsatisfactory results we received on synthetic datasets is that in such datasets, the most extreme inliers might also represent an absolute truth: for instance, the strongest inlier might simply be the image that looks the most like one of the majority's class digits. To accommodate that observation, we changed our definition of lowly-distinctive observations to the following definition: strong, yet non-extreme inliers. Our final definition of highly and lowly distinctive observations is as follows:

A highly distinctive observation: an observation to which at least one ensemble member gave a high anomaly score.

A lowly-distinctive observation: an observation to which all of the ensemble members gave a low anomaly score, but neither model gave an extremely low anomaly score.

Two challenges must now be addressed: first, since we are working in an unsupervised setting, we don't have access to labels that can indicate whether an observation is indeed an anomaly. Second, the notion of an observation's distinctiveness level, expressed via its abnormality degree, should represent the opinion of all the models in the ensemble, rather than the opinion of a single model.

### 2.2 High-Level Features

Anomaly-detection models are usually just the first step in a long pipeline; oftentimes, the anomaly scores predicted by the anomaly-detection model will not serve as the final output of the pipeline but instead will serve as the input for another step in the pipeline, in which a human analyst assigns a given treatment to a subset of the observations in the dataset; examples of such a treatment can be applying a business decision, such as blocking bank accounts affiliated with the predicted outliers; applying root cause analysis of a subset of observations with a high predicted anomaly score; performing a second, manual validation on the automated predictions to ensure there are no errors using the analyst's expertise in the domain; etc. In such cases, due to the large amount of time and cost of treating all the observations that received a high anomaly score by the model, the analyst will perform the treatment in a top-to-bottom manner. For instance, if the treatment is simply a manual validation of the top-ranked observations in terms of predicted anomaly scores, the analyst will first manually validate the top αn-ranked observations on the list of predicted anomaly scores; then, depending on various factors such as time and degree of error tolerance, she will manually validate the top 2αn-ranked anomalies; this process will continue until the top α=ηδ-ranked observations will be validated, where η denotes the contamination factor, and for 1+ϵ>=δ>=1. The reason for manually validating more than nη observations, the expected number of anomalies in the dataset, is to be able to capture the strongest false negatives. δ is determined either based on the estimation of the analyst of the accuracy of η; based on her estimation of the noise in the dataset; or based on the available resources.

In such a setting, the main factor that determines the treatment probability of an observation is not its absolute position, but instead, the cluster—a set of rank indices—within which it lies on the ranked list. The most common formalization of clusters parametrizes α using η and partitions the dataset into C=4 clusters:

$$[ 1 , {ηγ}_{1} n ] , 0 < {γ}_{1} < 1 : High - confidence outliers . \qquad Cluster 1$$

$$[ ( η {γ}_{1} n ) + 1 , η n ] : Low - confidence outliers . \qquad Cluster 2$$

$$[ ( η n ) + 1 , η n {γ}_{2} ] , {γ}_{2} > 1 : Low - confidence outliers . \qquad Cluster 3$$

$$[ ( η n {γ}_{2} ) + 1 , n ] : High - confidence outliers . \qquad Cluster 4$$

In our experiments, we found 0.25 <=γ₁<=0.5 and 3<=γ₂<=5 to yield the best results. Practically, those values are set by the analyst according to an accuracy-cost tradeoff of choice, and are fixed throughout the system run.

In a real-world production environment, the question of whether an observation, i, was mapped to rank cluster 1 or rank cluster C is significantly more important than whether it was ranked in position x or position x+1, since the decision whether i will be treated before it is sent out to the next pipeline's node is solely determined by the cluster to which i is mapped and the fixed system's hyperparameters γ₁, γ₂. This illustrates the fact that oftentimes, the most informative features of a model's predictions are not low-level features such as the exact scores each observation received by the model, but rather more high-level, generalizable features such as the cluster to which the exact score was mapped.

In the next subsection, we show how both low-level features such as rank index positions and high-level features such as rank cluster positions can be used to design correlation metrics that better capture the agreement among anomaly-detection models.

### 2.3 Agreement Among Ensemble Members

The simplest way to define agreement among ensemble members is via the intersection of their binary predictions: for instance, if more than M/2 models classify an observation as an anomaly, the ensemble will classify the observation as an anomaly. Such a method, however, is too coarse-grained and thus might fail to capture the underlying structure of the decision-making mechanism of each ensemble member. Thus, instead of using the binary prediction vectors of each model for measuring intra-ensemble agreement, we use the models' score vectors. We apply the rank transformation to the score vectors for normalization purposes so that the correlation is not biased towards one of the members. The task of measuring the agreement among ensemble models is therefore reduced to defining a proper notion of correlation between the M ranked anomaly score lists, {rₘ|m∈ [symbol] }.

### 2.3.1 Rank Correlation Metrics

The most commonly-used rank correlation metrics are Spearman's ρ and Kendall's τ. While Spearman's ρ aims at measuring the similarity of the normalized covariance, Kendall's τ measures correlation as the number of opposite (“discordant”) pairs in the two lists. The notion of a “discordant” pair is expressed using ξ, and used to define Kendall's τ (τ₂^{r}):

$${τ}_{2}^{r} = \frac{{\sum }_{i = 1}^{n} {\sum }_{j > i}}{n ( n - 1 ) / 2} \qquad ( 1 )$$

$$where :$$

$${ξ}_{{r}_{1} , {r}_{2}}^{r} ( i , j ) = ( \begin{matrix}1 & if sgn ( {r}_{1} [ i ] - {r}_{1} [ j ] ) = sgn ( {r}_{2} [ i ] - {r}_{2} [ j ] ) \\ 0 & if sgn ( {r}_{1} [ i ] - {r}_{1} [ j ] ) = - sgn ( {r}_{2} [ i ] - {r}_{2} [ j ] )\end{matrix}$$

In this version of Kendall's τ, the correlation lies in the range of [0, 1], rather than [−1, 1]; we believe that this version is more appropriate for quantifying the degree of ensemble's diversity in which we are only interested in determining the existence of a correlation rather than in its direction.

We argue that existing rank correlation methods cannot be used for accurately measuring the correlation between two (or more) lists that represent predicted, ranked anomaly scores. First, both Spearman's ρ and Kendall's τ implicitly assume that all the observations have an equal contribution to the correlation between the two ranked lists. That implicit assumption oftentimes doesn't accurately represent the correlation we would like to capture between the predicted anomaly scores of two models. For instance, looking at Kendall's τ, do all discordant anomaly-score pairs equally contribute to the correlation among the models? the answer is, oftentimes, no. Assume that we have only two models in the ensemble and for two observations, i, j, we observe the following ranks: r₁[i]=1, r₁[j]=n−1, r₂[i]=n−2, r₂[j]=2. i and j will be considered as a discordant pair, and their contribution to the final correlation will be 0. Now assume we are given the ranks of another pair, i*, j*: r₁[i*]=n/2, r₁[j*]=n/2+1, r₂[i*]=n/2+1, r₂[j*]=n/2. i* and j* will also be considered as a discordant pair, and their contribution to the correlation score will be the same as the contribution of i and j, either −1 or 0. Intuitively, when attempting to quantify the correlation between two anomaly-detection models using their predicted anomaly scores, the discordance of i, j should be penalized much heavier than the discordance of i*,j*, since the former implies a much harsher disagreement: while model m₁ considered i to be one of the strongest anomalies, and j to be one of the strongest inliers, model m₂ determines the exact opposite. While models m₁ and m₂ also disagree on the “anomaly rank” of i* and j*, they are both ranked as inliers by each model, and thus this disagreement should be penalized less severely than that of i,j.

But there is another, more profound reason why existing rank correlation methods cannot be used to fully capture the agreement among anomaly-detection models. A discordant pair is defined to be one such as sgn(f(r₁[i])−f(r₁[j]))=−sgn(f(r₂[i])−f(r₂[j])). In Kendall's τ, f is the identity function, [symbol] . A discordant pair is a pair such that i is ranked higher than j in r₁, whereas i is ranked lower than j in r₂. We claim that such a definition of discordance is too fine-grained in the context of measuring the agreement among anomaly-detection models, and thus cannot function as a generalizable correlation metric for measuring agreement among anomaly-detection models. Let us look at the following example:

$${r}_{1} [ i ] = \frac{η}{2} , {r}_{1} [ j ] = \frac{η}{2} + 1 , {r}_{2} [ i ] = 2 η + 2 , {r}_{2} [ j ] = 2 η + 1$$

$${r}_{1} [ {i}^{*} ] = \frac{η}{2} , {r}_{1} [ {j}^{*} ] = 2 η + 1 , {r}_{2} [ {i}^{*} ] = 2 η + 2 , {r}_{2} [ {j}^{*} ] = \frac{η}{3}$$

Both i, j and i*, j* will be considered as discordant pairs according to Kendall's τ. But do those two notions of “oppositely ranked”, the one represented by the relation of i and j and the one represented by the relation of i* and j*, have a similar contribution to the agreement between the two models? we claim that they do not. The core reason for that is that the opposite rank relation of i* and j* in r₁ and r₂ is a much stronger indicator of a disagreement between the two models compared to the opposite rank relation of i and j.

Let us try and formalize this observation. In Subsection 2.2, we have discussed the rank cluster treatment pattern commonly used when analyzing anomaly-detection models' output. In such a case, the analysis of the ranked score list is done in clusters, where the probability of treating an observation depends not only on its index on the ranked list, but also on the rank cluster to which the rank index is mapped. Assuming a small number of clusters, instead of determining the relation between a pair of observations according to the relation between their rank indices, we can determine the relation between them according to the rank clusters to which their rank indices are mapped. Defining the relation between observations using their clusters—a generalization of their exact rank position on the ranked list, serves as the basis of a fuzzy rank correlation metric, a generalization of an exact rank correlation, in which in order for a pair of observations to negatively contribute to the correlation it must reflect an opposite rank cluster position relation, rather than an opposite rank index position relation. A discordant pair in this case will defined as follows: sgn(β(r₁[i])−β(r₁[j]))=−sgn(β(r₂[i])−β(r₂[j])) where β is the cluster-mapping function β: R−>C, |R|=n and |C|=C. That is, f is now the cluster-mapping function instead of the identity function, and a discordant

```
Algorithm 1 [symbol]
Input: [symbol]  : {rₘ|m ∈ [symbol]  } M ranked anomaly score lists
Output: [symbol]   a multi-way, exact rank correlation coefficient based
on binary conjunction
  1: f = [symbol]
  2: for i ∈ range(0, n) do
  3:  indᵢ = Ω(i, [symbol]  )
  4:  wᵢ = w(indᵢ)
  5:  for j ∈ range(i, n) do
  6:  smaller = 0
  7:  bigger = 0
  8:  indⱼ = Ω(j, [symbol]  )
  9:  wⱼ = w(indⱼ)
10:  wᵢⱼ = Ω_{*} (wᵢ, wⱼ)
11:  sum_{w} = sum_{w} + wᵢⱼ
12:  for m ∈ range(0, [symbol]  ) do
13:  if f(rₘ [i]) < f(rₘ [j]) then
14:  smaller = smaller + 1
15:  else
16:  bigger = bigger + 1
17:  end if
18:  end for
19:  if smaller = = M ∨ bigger = = M then
20:  corr = corr + wᵢⱼ
21:  end if
22:  end for
23: end for
24:  ${τ}_{{M}^{b}}^{r} = \frac{corr}{{sum}_{w}}$
25: return [symbol]
```

pair is a pair that reflects a negative rank cluster position relation as opposed to a negative rank index position relation. Assuming the existence of 4 clusters as described in Subsection 2.2, we can see that although according to the prior definition of discordance, both i, j and i*, j* are marked as discordant, according to the new discordance definition only i*, j* will be marked as discordant, hence negatively influencing the correlation between r₁ and r₂ while i, j will be marked as concordant (i belongs to the same cluster as j both in r₁ and in r₂), and will thus have a positive contribution to the correlation score. Indeed, the uncertainty that results from assigning i* and j* to different clusters is significantly stronger than the uncertainty that results from assigning i, j to the same cluster, even if their internal ranking within the cluster is inconsistent across the models.

Combining the two observations, we present a generalization of Kendall's τ, specifically suited to measuring the correlation between two anomaly-detection models: a weighted, fuzzy correlation metric based on rank clusters instead of rank indices:

$${τ}_{2}^{c} = \frac{{\sum }_{i = 1}^{n} {\sum }_{j > i} {Ω}_{*} ( w ( Ω ( {r}_{1} [ i ] , {r}_{2} [ i ] ) ) , w ( Ω ( {r}_{1} [ j ] , {r}_{2} [ j ] ) ) ) {{ξ}_{{r}_{1} , {r}_{2}}^{c} ( i , j )}_{}}{{\sum }_{i = 1}^{n} {\sum }_{j > i} {Ω}_{*} ( w ( Ω ( {r}_{1} [ i ] , {r}_{2} [ i ] ) ) , w ( Ω ( {r}_{1} [ j ] , {r}_{2} [ j ] ) ) )} \\ where : {ξ}_{{r}_{1} , {r}_{2}}^{c} ( i , j ) = \{ \begin{matrix}1 & if sgn ( β ( {r}_{1} [ i ] ) - β ( {r}_{1} [ j ] ) ) = sgn ( β ( {r}_{2} [ i ] ) - β ( {r}_{2} [ j ] ) ) \\ 0 & if sgn ( β ( {r}_{1} [ i ] ) - β ( {r}_{1} [ j ] ) = - sgn ( β ( {r}_{2} [ i ] ) - β ( {r}_{2} [ j ] ) )\end{matrix} \qquad ( 2 )$$

Each pair of observations is weighted: first, we compute an aggregated rank index of i over models m₁, m₂ using an index aggregation function Ω, and then map the aggregated index into a weight, resulting in the term \hat{Ω}(i)=w(Ω(r₁[i], r₂[i])), where \hat{Ω} is the multi-model weighting scheme. This term represents i's aggregated weight over all M models (in this case, M=2). Next, we compute a similar aggregated weight for j. Finally, we aggregate both i's and j's weights using Ω_{*}; this yields the final weight of the pair i, j. In our experiments, we choose Ω_{*} to be the max( ) operator, to bias the combined weight towards the more anomalous observation among i and j. We elaborate on both the index-aggregation methods and weighting schemes we have experimented with in Subsection 2.4 and in Section 4.1.

### 2.3.2 Multi-Way Correlation Metrics

So far, we have seen two rank correlation metrics: Kendall's τ—a two-way, exact rank correlation metric (τ₂^{r}) and a two-way, fuzzy rank correlation metric (τ₂^{c}). We now describe how to extend both τ₂^{r} and τ₂^{c} to the multi-way case that is needed for measuring the degree of correlation among the M models in the ensemble.

Our multi-way, exact correlation metric extends τ₂^{r} using one of two approaches:
1. τ_{M}_{^{b}}^{r}: A multi-way, exact rank correlation metric based on binary conjunction: τ_{M}_{^{b}}^{r} extends τ₂^{r} to the multi-way case using a binary notion of M agreement, by requiring all the models to induce the same type of relation between i and j. A pair i, j is considered concordant only if sgn(rₘ[i]−rₘ[j]) carries the same sign for all the models m∈ [symbol] as shown in Algorithm 1. Note that the procedure described in Algorithm 1 can also be used for computing a multi-way, fuzzy rank correlation based on rank clusters if f=β.
2. τ_{M}_{^{m}}^{r}: A multi-way, exact rank correlation metric based on the largest concordant set: While a conjunction-based multi-way extension of τ₂^{r} is simple and straightforward, it is not fine-grained enough: for instance, both an ensemble with a (M−1, 1) disagreement on i, j and an ensemble with a (└M/2┘, ┌M/2┐) disagreement on i, j will mark i, j as a discordant pair. Thus, both cases will have an equal contribution to the correlation of the M models, which is obviously not the case as the disagreement on i, j in the latter case is much stronger than the disagreement in the former case. The inability to differentiate between both cases results from the fact that our generalization of τ to the multi-way case was done using a binary measure of correlation, which might not have the adequate expressive power to capture more delicate nuances that exist in the multi-way case. Thus, we offer an alternative generalization of τ to the multi-way case: the new multi-way correlation metric considers not only whether or not the models agree on the direction of the relation between a pair i, j, but also considers the number of agreeing/disagreeing models using the notion of “largest concordant set” by partitioning the ensemble members into l=2 sets according to the type of relation they induce on i, j. The strength of correlation on i, j among the M models can be defined as the cardinality of the largest set. The idea is illustrated in Algorithm 2.

Note that the procedure described in Algorithm 2 can also be used for computing a multi-way, fuzzy rank correlation based on rank clusters by (1) setting f=β and (2) setting l=3 and adding an additional set to “smaller” and “bigger”, “equal”; this is because in the exact-rank case, only two types of relations exist between a pair of observations i and j: either rₘ[i]<rₘ[j], or rₘ[i]>rₘ[j]. Thus, each model is categorized into one of l=2 sets. On the contrary, in the fuzzy case there exist three types of relations between i, j: either β(rₘ[i])<β(rₘ[j]), β(rₘ[i])>β(rₘ[j]) or β(rₘ[i])=β(rₘ[j]). The max( ) method will return the size of the biggest set of the three.

After experimenting with both approaches, we found τ_{M}_{^{m}}^{r} to yield better results.

Our multi-way, fuzzy correlation metric extends τ₂^{c} by combining the advantages of exact-rank-based discordance and fuzzy-rank-based discordance thus balancing the correlation so it is neither too general nor too fine-grained using the following two key ideas:
1. Unlike ξᵣ_{₁}_{,r}_{₂}^{c}, we enable discordance that is based on opposite rank positions; however, unlike ξᵣ_{₁}_{,r}_{₂}^{r}, discordance that is based on opposite rank positions is only allowed between observations i, j that belong to the same cluster both in r₁ and r₂. That is, we only consider intra-cluster exact-rank-based discordance. Inter-cluster exact-rank-based discordance is not considered.
2. The definition of exact-rank-based discordance is relaxed; for each pair, i, j, the relaxation is proportional to the cluster size to which i and j are mapped.

The discordance level of i and j is measured as follows:

$${ξ}_{{r}_{1} , {r}_{2}}^{r c} ( i , j ) = \{ \begin{matrix}0 & if ( β ( {r}_{1} [ i ] ) \neq β ( {r}_{2} [ i ] ) ⋁ ( β ( {r}_{1} [ j ] ) \neq β ( {r}_{2} [ j ] ) \\ 1 & if ( β ( {r}_{1} [ i ] ) = β ( {r}_{2} [ i ] ) ⋀ ( β ( {r}_{1} [ j ] ) = β ( {r}_{2} [ j ] ) ⋀ \\ & ( β ( {r}_{1} [ i ] ) \neq β ( {r}_{1} [ j ] ) \\ 1 & if ( β ( {r}_{1} [ i ] ) = β ( {r}_{2} [ i ] ) = ( β ( {r}_{1} [ j ] ) = β ( {r}_{2} [ j ] ) ⋀ \\ & sgn ( {r}_{1} [ i ] ) - {r}_{1} [ j ] ) = sgn ( {r}_{2} [ i ] ) - {r}_{2} [ j ] \pm δ \vert β ( {r}_{1} [ i ] ) \vert ) \\ 0 & if ( β ( {r}_{1} [ i ] ) = β ( {r}_{2} [ i ] ) = ( β ( {r}_{1} [ j ] ) = β ( {r}_{2} [ j ] ) ⋀ \\ & sgn ( {r}_{1} [ i ] ) - r 1 [ j ] ) = - sgn ( {r}_{2} [ i ] ) - {r}_{2} [ j ] \pm δ \vert β ( {r}_{1} [ i ] ) \vert )\end{matrix} \qquad ( 3 )$$

There are multiple cases to consider in the above definition: first, if either i is mapped to different clusters in r₁ and r₂, or j is mapped to different clusters in r₁ and r₂, the pair i, j is not even being queried for its discordance status and is treated as negatively affecting the correlation. If r₁[i]=r₂[i]=c₁ and r₁[j]=r₂[j]=c₂ and ¬(c₁=c₂), we immediately consider i, j as concordant, as inevitably i and j will share a similar relative position in both ranked lists. Otherwise, if c₁=c₂, we determine the discordance status of i and j based on a relaxed measure of their rank positions within cluster c₁. Specifically, an opposite exact rank relation between i and j in r₁ and r₂ is no longer a sufficient condition for i,j to be discordant. Rather, they must be δ-oppositely positioned within cluster c₁: that is, i and j's ranks are oppositely positioned in at least δ|β(r₁[i])| indices. Note that the number of indices in which we allow i and j to be oppositely ranked before classifying them as discordant is designed so that it positively correlates with i and j's abnormality level: the larger the cluster is—i.e. the more bottom-ranked observations will be mapped to it—the more flexible is our measure of discordance within that cluster. This idea reflects our expectation that opposite ranks of observations that represent anomalies (having top ranks) should have a more negative influence on the correlation than opposite positions of observations that represent inliers.

The fuzzy, multi-way correlation metric that we use is based on ξ_{r1,r2}^{rc}, extended to the multi-way case as shown in Algorithm 3 using the notion of the “largest concordant set”: the set of models M′⊆ [symbol] such that for each two models in M′, m*, m**, β(r_{m*}[i])=β(r_{m**}[i])=c₁ and β(r_{m*}[j])=β(r_{m**}[j])=c₂, and either c₁≠c₂ or, c₁=c₂ and within that cluster, sgn((r_{m*}[i]−(r_{m*}[j])=sgn((r_{m**}[i]−(r_{m**}[j]±δ|(c₁)|). This multi-way definition of concordance captures the following ideas on the relation between two models, m*, m**: if i is mapped to different clusters in r_{m*} and r_{m**}, or j is mapped to different clusters in r_{m*} and r_{m**}, the pair i, j is not even being queried for its discordance status and is treated as negatively affecting the correlation, thus m*, m** cannot be members of the same concordant set. If β(r_{m*}[i])=β(r_{m**}[i])=c₁ and β(r_{m*}[j])=β(r_{m**}[j])=c₂ and ¬(c₁=c₂), we immediately consider i, j as concordant, as inevitably i and j will share a similar relative position in both ranked lists, and thus m*, m** will both be part of the same concordant set. Otherwise, if c₁=c₂, we determine the discordance status of i and j based on a relaxed measure of their rank positions within cluster c₁. Specifically, an opposite exact rank relation between i and j in r_{m*} and r_{m**} is no longer a sufficient condition for i, j to be discordant. Rather, they must be δ-oppositely positioned within cluster c₁: that is, i and j's ranks are oppositely positioned in at least δ|β(r_{m*}[i])| indices. Thus, m*, m** will belong to the same concordant set only if i, j either share the same exact rank relation in both r_{m*} and r_{m**}, or if i, j are oppositely ranked in r_{m*} and r_{m**} by at most δ|β(r_{m*}[i])| indices within the cluster, β(r_{m*}[i]) they are both mapped to on the ranked lists r_{m*} and r_{m**}.

```
Algorithm 2 [symbol]
Input: [symbol]  : {rₘ |m ∈ [symbol]  } M ranked anomaly score lists
Output: [symbol]  : a multi-way, exact rank correlation coefficient based
on the size of the largest concordant set
  1: f = [symbol]
  2: for i ∈ range(0, n) do
  3:  indᵢ = Ω(i, [symbol]  )
  4:  wᵢ = w(indᵢ)
  5:  for j ∈ range(i, n) do
  6:  smaller = 0
  7:  bigger = 0
  8:  indⱼ = Ω(j, [symbol]  )
  9:  wⱼ = w(indⱼ)
10:  wᵢⱼ = Ω_{*} (wᵢ, wⱼ)
11:  sum_{w} = sum_{w} + wᵢⱼ
12:  for m ∈ range(0, [symbol]  ) do
13:  if f(rₘ[i]) < f(rₘ[j]) then
14:  smaller = smaller + 1
15:  else
16:  bigger = bigger + 1
17:  end if
18:  end for
19:  corr = corr + (M − max(smaller, bigger) * wᵢⱼ
20:  end for
21: end for
22:  ${τ}_{{M}^{m}}^{r} = 1 - \frac{corr}{s u {m}_{w} * ( M - ⌈ \frac{M}{2} ⌉ )}$
23: return [symbol]
```

### 2.4 Putting It All Together

The key idea for measuring the extent to which an ensemble is Accurately Diverse is assessing the degree of both the exact rank correlation and fuzzy rank correlation of its members' predictions, each time using a different weighted version of the dataset. Specifically, we use two multi-way rank correlation metrics: an exact-rank correlation metric based on rank indices, τ_{M}_{^{m}}^{r}, and a fuzzy-rank correlation metric based on rank clusters, τ_{M}^{c}. Each correlation metric is computed using a different set of weights, which bias the correlation towards a different type of observations in the dataset based on the observations' distinctiveness level: when computing a fuzzy-rank correlation metric based on rank clusters, we assign higher weights to observations which at least one model found to be highly anomalous; on the other hand, when computing an exact-rank correlation metric based on rank indices we assign higher weights to observations which (a) all the models found to be inliers and (b) no model found to be an extreme inlier.

The requirement for a strong intra-ensemble agreement on the general trend of each ensemble member's predictions is approximated by the ensemble obtaining a high degree of fuzzy rank correlation computed using a multi-model weighting scheme, \hat{Ω}^{c}, that upweights strong outliers. The requirement for a strong intra-ensemble disagreement on the exact ordering of each ensemble member's predictions is approximated by the ensemble obtaining a low degree of exact rank correlation computed using a multi-model weighting scheme, \hat{Ω}^{r}, that upweights non-extreme inliers.

As noted in Subsection 2.3.1, our multi-model weighting scheme, Ω, is composed of two components: a rank index aggregation function, Ω, and a weighting scheme, w, applied to the aggregated rank index.

Weighting scheme The weighting scheme, w, that we found to work best for upweighting highly-distinctive observations—strong outliers, is an exponential weighting scheme:

$$w ( i ) = 1 - ( 1 - ( {e}^{- {( \frac{i}{{δ}_{η}} )}^{b}} ) ) \qquad ( 4 )$$

where b∈[2, 4] and δ∈[2, 5]. Such a weighting scheme assigns high weights only to strong, predicted outliers, where the exact definition of “strong” can be controlled using the choice of δ.

The weighting scheme that we found to work best for upweighting lowly distinctive observations—non-extreme inliers, is a bell-shaped weighting function based on the

```
Algorithm 3 [symbol]
Input: [symbol]  : {rₘ|m ∈ [symbol]  } M ranked anomaly score lists
Output: [symbol]  : a Fuzzy, multi-way correlation coefficient
  1: for i ∈ range(0, n) do
  2:  indᵢ = Ω(i, [symbol]  )
  3:  wᵢ = w(indᵢ)
  4  for j ∈ range(i, n) do
  5:  indⱼ = Ω(j, [symbol]  )
  6:  wⱼ = w(indⱼ)
  7:  wᵢⱼ = Ω_{*} (wᵢ, wⱼ)
  8:  sum_{w} = sum_{w} + wᵢⱼ
  9:  smaller = [ [symbol]  ]
10:  bigger = [ [symbol]  ]
11:  equal = [ [symbol]  ][ [symbol]  ]
12:  for m ∈ range(0, [symbol]  ) do
13:  if (¬ β(rₘ[i]) = β(rₘ[j])) then
14:  equal[β(rₘ[i]) − 1][β(rₘ[j]) − 1]+ = 1
15:  else
16:  if |rₘ[i] − rₘ[j]| <= δ * |β(rₘ[i])| then
17:  smaller[β(rₘ[i]) − 1]+ = 1
18:  bigger [β(rₘ [i]) − 1]+ = 1
19:  else
20:  if rₘ[i] < rₘ[j] then
21:  smaller[β(rₘ[i]) − 1]+ = 1
22:  else
23:  bigger[β(rₘ [i]) − 1]+ = 1
24:  end if
25:  end if
26:  end if
27:  end for
28:  maxₛₘₐₗₗₑᵣ = max(smaller)
29:  max_{bigger} = max(bigger)
30:  max_{equal} = max(equal)
31:  maxᵣₑₗ = max(maxₛₘₐₗₗₑᵣ, max_{bigger}, max_{equal})
32:  corr = corr + (M − maxᵣₑₗ) * wᵢⱼ
33:  end for
34: end for
35:  ${τ}_{M}^{c} = 1 - \frac{corr}{{sum}_{w} * ( M - ⌈ \frac{M}{c + {c}^{2}} ⌉ )}$
36: return [symbol]
```

Subbotin distribution: a Gaussian-shaped curve with a plateau in its center. The size of the plateau can be set using λ to control the amount of uniformity among highly-weighted observations:

$$w ( i ) = {e}^{- {( \frac{\vert i - n μ \vert}{n σ} )}^{λ}} \qquad ( 5 )$$

where μ∈[0.5, 0.75], σ∈[0.1, 0.3], and λ∈[2, 10]. Such a weighting scheme assigns high weights only to “normal” inliers: inliers that are strong enough but are also not the most extreme inliers in the dataset.

Rank index aggregation function Ω, the rank index aggregation function that we use must be such that is naturally biased towards smaller rank indices; that is, biased towards ensemble members that assigned the observation the highest predicted anomaly score. Note that this requirement should hold when weighting both highly distinctive observations and lowly distinctive observations, as in both cases we care most about the “highest” rank given by an ensemble member: in the former case, we upweight observations only if their highest rank was “high enough”; in the latter case, we upweight observations only if their highest rank was “low enough”. The rank index aggregation scheme we found to yield the best results is the harmonic mean.

The multi-model weighting scheme, \hat{Ω}^{r}, that we found to work best for upweighting lowly distinctive observations is:

$${\hat{Ω}}^{{}_{r}} ( i ) = {e}^{- {( \frac{\vert \frac{M}{\sum m = {1}^{M} 1 / {r}_{m} [ i ]} - n μ \vert}{n σ} )}^{λ}} \qquad ( 6 )$$

The multi-model weighting scheme, \hat{Ω}^{c}, that we found to work best for upweighting highly distinctive observations is:

$${\hat{Ω}}^{{}_{c}} ( i ) = 1 - ( 1 - ( {e}^{- {( \frac{\frac{M}{\sum m = {1}^{M} 1 / {r}_{m} [ i ]}}{δ η} )}^{b}} ) ) \qquad ( 7 )$$

To conclude, we assess the extent to which an ensemble is Accurately Diverse according to two criteria: (1) a high degree of fuzzy rank correlation on strong outliers and (2) a low degree of exact rank correlation on non-extreme inliers. The higher the correlation in (1) and the lower the correlation in (2), the more Accurately Diverse the ensemble is.

### 3 Using the Accurately-Diverse Ensemble for Unsupervised Evaluation

In Section 2, we have developed the main criteria that an ensemble of anomaly-detection models must follow in order to be Accurately-Diverse and claimed that it will perform better than the average anomaly-detection model on unsupervised anomaly-detection tasks. However, there could be situations where an ensemble model cannot or should not be used; for instance, regulatory or legal constraints might require the use of a single model. Alternatively, the analyst might have a strong prior knowledge of the nature of the task and the dataset that leads her to favor a specific type of model.

In such cases, though a model-selection procedure is not required, a model evaluation method is crucial for assessing the true performance of the model. Again, because we assumed an unsupervised setting, supervised evaluation methods using a labeled validation set cannot be used to evaluate the chosen model. In this section, we use our Accurately-Diverse ensemble approach to design a new unsupervised evaluation metric for the purpose of benchmarking unsupervised anomaly-detection models.

The core idea of the “unsupervised ensemble divergence” score, [symbol] , is to use a distance metric, tailored specifically to anomaly-detection tasks, measured between the prediction of the model to be evaluated, m*, and the aggregated prediction of an Accurately-Diverse ensemble. Specifically, for each observation, i, in the dataset, we first compute [symbol] , the distance between the Accurately-Diverse ensemble's aggregated prediction and the candidate model's prediction. We then compute ζ, the ensemble's confidence level on observation i, approximated by the degree of unanimity of the ensemble members on the prediction of observation i. Finally, since we are evaluating an anomaly-detection model and thus interested more in its accuracy on outliers, we compute the relative importance of i to the score by assigning i a weight, wᵢ, that aggregates the position of i in both the ranked score list predicted by the candidate model and the ranked score list predicted by the Accurately-Diverse ensemble. The final contribution of i to the evaluation score is proportional to a combination of the distance, the confidence, and the weight of observation i. Finally, the score is normalized using a distance-dependent normalization factor, N.

As seen in Algorithm 4, we start by building an Accurately-Diverse ensemble as explained in previous sections and combining its members' predictions using an aggregation function such as the median (see Section 4, resulting in the list of aggregated predictions, [symbol] , for each observation in the dataset. We then re-rank the aggregated-prediction list, resulting in a new ranked list, [symbol] , and compute the distance between the following ranked lists: the ensemble's re-ranked aggregated predictions, [symbol] , and the candidate model's ranked predictions, r_{m*}. We have experimented with multiple rank distance metrics, and found a fuzzy rank distance metric based on rank clusters, [symbol] ^{c}, to yield the best results:

$${𝒟}^{c} ( {r}_{{m}^{*}} , {r}_{𝒜} ) = {\sum }_{i = 1}^{n} \vert β ( {r}_{{m}^{*}} [ i ] ) - β ( R ( {r}_{𝒜} [ i ] ) ) \vert \qquad ( 8 )$$

While the distance represents the level of opinion divergence between the candidate model and the ensemble, it is also important to understand how confident the ensemble's opinion actually is. Generally speaking, we would like such an opinion divergence to be scaled proportionally to the level of confidence of the ensemble members. If the ensemble members are highly inconclusive with regards to a given observation, having very different opinions about its anomaly level, the distance between the candidate model's and the ensemble's opinions with respect to that observation should not strongly influence the evaluation score. On the other hand, if all the ensemble members are highly conclusive that the observation is either an inlier or outlier, then the distance between the candidate's model prediction and the ensemble's prediction should have a high influence on the evaluation score.

Below we list multiple confidence metrics that aim at measuring the internal agreement among the ensemble members on a given observation, i. All the confidence metrics can be limited to the interval [1−(1/υ), 1] for a υ of choice, to control the influence of the confidence on the final score.
1. The inverse of the difference between the highest rank of i and the lowest rank of i among the ensemble members.

$$ζ ( i ) = 1 - \frac{ℳ𝒜𝒳 ( {\{ {r}_{m} [ i ] \}}_{m ∈ ℳ} \} ) - ℳℐ𝒩 ( {\{ {r}_{m} [ i ] \}}_{m ∈ M} \} )}{v ( n - 1 )} \qquad ( 9 )$$

2. The absolute difference between each ensemble member's rank of i, and the ensemble's average rank of i.

$$ζ ( i ) == 1 - \frac{{\sum }_{m ∈ ℳ} \vert 𝒜𝒱ℰℛ𝒜𝒢ℰ ( {\{ {r}_{m} [ i ] \}}_{m ∈ ℳ} ) - {r}_{m} [ i ] \vert )}{ν ( ⌈ M / 2 ⌉ * \vert n - V ( M ) \vert + ⌊ M / 2 ⌋ * \vert V ( M ) - 1 \vert )} \\ where V ( M ) = \frac{⌊ M / 2 ⌋ + n ⌈ M / 2 ⌉}{M} \qquad ( 10 )$$

3. The absolute difference between each ensemble member's rank of i, and the ensemble's median rank of i.

$$ζ ( i ) = 1 - \frac{{\sum }_{m ∈ ℳ} \vert ℳℰ𝒟ℐ𝒜𝒩 ( {\{ {r}_{m} [ i ] \}}_{m ∈ ℳ} ) - {r}_{m} [ i ] \vert )}{ν ( n - 1 ) ⌊ M / 2 ⌋} \qquad ( 11 )$$

4. The number of ensemble members that mapped i's rank to the same cluster as the cluster to which i's rank in the aggregated ensemble prediction was mapped.

$$ζ ( i ) = 1 - \frac{M - {\sum }_{m ∈ ℳ} {β ( {r}_{m} [ i ] ) = = β ( R ( {r}_{𝒜} [ i ] ) )}_{}}{ν M} \qquad ( 12 )$$

Each metric captures a somewhat different measure of confidence; in our experiments, we found the median-based confidence metric to yield the highest Spearman correlation between the [symbol] score and all the supervised evaluation scores we have tested.

[symbol] aimed at capturing the divergence between the candidate model's and the ensemble's opinions, and (aimed at quantifying the ensemble's confidence in its opinion;

```
Algorithm 4 [symbol]   score
Input: [symbol]  : M anomaly-detection models, D: dataset
Output: [symbol]    : evaluation score of model m*
  1: E = Build Ensemble( [symbol] )
  2: r_{A} = GetAggregatedRankedPredictions(E, D)
  3: R(r_{A}) = Rank(r_{A})
  4: r_{m*} = RankPredict(m*, D)
  5: for i ∈ range(0, n) do
  6: dᵢ = D(r_{m*}[i], R(r_{A}[i]))
  7: cᵢ = ζ (i, [symbol] )
  8: wᵢ = w(Ω(r_{m*}[i], R(r_{A}[i])))
  9: score = score + (dᵢ * cᵢ * wᵢ)
10: end for
11: [symbol]   = 1 − (score/N)
12: return [symbol]
```

the final component of i's contribution to the evaluation score, its weight, aims at capturing the importance of observation i to the overall evaluation metric compared to other observations in the dataset. Since [symbol] aims at evaluating anomaly-detection models, the relative importance of each observation within the evaluation score is proportional to its level of distinctiveness, where the contribution of highly-distinctive observations to the evaluation score are weighted more than the contribution of other observations. The weight of each observation, i, is computed by aggregating the predicted abnormality level of i according to the candidate model, and the predicted abnormality level of i according to the ensemble. The weighting schemes we have experimented with are presented in Subsection 4.1. In our experiments, we found the best weighting scheme to vary between datasets; yet, the multiplicative weighting scheme yielded the highest Spearman correlation between the [symbol] score and two of the supervised evaluation scores we have tested: PR AUC and prec@n, followed by the exponential weighting scheme with α=δη and δ∈[2, 4]. The highest Spearman correlation between the [symbol] score and the ROC AUC score resulted from applying a uniform weighting scheme—wᵢ=1 for all i∈D.

Results comparing the [symbol] metric to supervised evaluation metrics can be found in Section 4.

### 4 Experimental Evaluation

### 4.1 Weighting Schemes

The [symbol] unsupervised evaluation metric assumes the existence of a weighting scheme in which the higher an observation appears on ranked anomaly score list (i.e. the more anomalous it is), the higher the weight it should be assigned. Both the fuzzy rank correlation metric and the [symbol] evaluation metric also implicitly assume that the weight decrease rate should not be linear across all the observations on the list: for instance, the decrease rate among predicted outlier observations (those with rank <=γ₁ηn), γ₁<1, should be significantly slower than the decrease rate among predicted inlier observations; in fact, it might be the case that, starting from a certain index, γ₂ηn, γ₂>1 the weights assigned to observations should remain fixed on a very small value, either 0 or very close to 0.

We, therefore, have the following requirements from our weighting scheme:
1. The weights should lie in the interval [0, 1], and the most anomalous observation should be assigned the weight 1.
2. The weight of each observation, i, should be an inverse function of i's index in the ranked score list.
3. The weight decrease rate should not be linear across all the observations on the list. Furthermore, the analyst should be able to control the decrease rate so as to set a higher decrease rate within certain rank clusters within the list.

Terminology We assume that the observation that received the highest anomaly score is assigned a rank of 1, and thus positioned in the index 0 in the ranked anomaly score list. The range of each weighting scheme is thus [0, n−1].

We present four weighting schemes that follow the three requirements listed above. Each scheme induces a somewhat different weight distribution over the observations and hence the exact weighting scheme to be used should be chosen according to the specific task at hand.

### 1. Logarithmic Reduction Factor

$$w ( i ) = \frac{1}{log ( α i + 10 )} \qquad ( 13 )$$

The rate of weight decrease is higher among smaller indices (indices at the top of the list). Thus the variance among weights within the same cluster might become quite large, especially in anomalous clusters. For this reason, this weighting scheme is suited to the scenarios where the weight assignment should be strongly biased towards top-ranked anomalies, and where an error on one of the top-ranked anomalies should result in a more severe penalty than an error on one of the bottom-ranked anomalies. The decrease rate can be explicitly controlled using α: the higher α is, the higher the weight decrease rate is.

### 2. Cosine Reduction Factor

$$w ( i ) = {w}_{e n d} + \frac{{w}_{s t a r t} - {w}_{e n d}}{2} ( 1 + cos ( 1 + \frac{α i π}{{n}_{e n d}} ) ) \qquad ( 14 )$$

wₛₜₐᵣₜ should be set to the value of the highest weight, in our case, 1. w_{end} should be set according to the lowest weight we would like any observation on the list to be assigned—this should be a very small number, and n_{end} should be set to the index that will be assigned the weight w_{end}. Due to the parametrization induced by our specific application (i.e. weight assignment based on sorted lists' indices), the rate of intra-cluster weight decrease using that weighting scheme will be quite moderate compared to other weighting schemes, hence this weighting scheme is suited to scenarios where the weight assignment should be quite uniform over all the observations within a given cluster, for instance in cases where we need to treat all the anomalies in a similar manner. While the decrease rate can be implicitly controlled via n_{end}, α should be used to control the decrease rate within different clusters.

### 3. Multiplicative Reduction Factor

$$w ( i ) = α w ( i - 1 ) , α < 1 , w ( 0 ) = 1 \qquad ( 15 )$$

The rate of weight decrease is steep, and is identical among both high-ranked observations and low-ranked observations. Hence it is suited to scenarios where the weight assignment should be strongly biased towards outliers, or when we would like to have explicit control over the decay rate of the weight of each index as a function of the weight of the index that preceded it. Here as before we can choose a different α for different clusters within the sorted score list.

### 4. Exponential Reduction Factor

$$w ( i ) = 1 - ( 1 - ( {e}^{- {( \frac{i}{α} )}^{b}} ) ) \qquad ( 16 )$$

The rate of weight decrease is lower among top and bottom indices and higher among middle indices; hence this weighting scheme is suited to scenarios where it is required to assign an equal treatment to either all the strongest outliers; all the strongest inliers; or both, or when the weighting scheme should induce a similar trend of weights over both the strongest outliers and the strongest inliers. The notion of “strongest” can be controlled using α and b. b controls how steep the decrease in the middle of the s-shape is: the higher b is, the more similar weights of “strong inliers” are, and the steeper the decrease among weights that are in between. α controls the number of observations treated as strong inliers and strong outliers using b's definition; a good rule of thumb would be setting it as a function of n and η.

### 4.2 Experimental Results

Datasets In order to evaluate our invention as described in previous sections, we use multiple publicly available datasets. In datasets where η>0.2, we downsampled the outlier class so η always lies in the range [ϵ, 0.2] as in our view, classification tasks in

TABLE 1
A comparison of the Accurately-Diverse ensemble to the
average single model (PR AUC, prec@n)

| Dataset | Best ensemble | Worst ensemble | AS | RSPS |
|---|---|---|---|---|
| smtp [26, 29] | .52, .55 | .02, .06 | .19, .35 | .03, .2 |
| backdoor [21] | .48, .47 | .04, .06 | .28, .29 | .2, .25 |
| satellite [26, 28] | .6, .55 | .25, .3 | .48, .46 | .44, .44 |
| magic. gamma [5] | .48, .43 | .35, .38 | .39, .37 | .37, .35 |
| fraud [24] | .25, .3 | .02, .06 | .12, .19 | .12, .06 |
| campaign [24] | .34, .38 | .13, .13 | .25, .3 | .23, .29 |
| mnist [15] | .38, .41 | .15, .17 | .3, .31 | .26, .3 |

which the size of the minority class is 20% or higher do not fall under the category of anomaly-detection tasks, but should rather be considered as standard, yet imbalanced, classification tasks.
Benchmarks and results Our first experimental task is to evaluate the performance of our Accurately-Diverse ensemble when used as a standalone unsupervised anomaly-detection model. This task is not straightforward, as it is not immediately clear which benchmarks are appropriate for the unsupervised setting. For instance, an inappropriate benchmarking methodology would be to simply compare the results of the Accurately-Diverse ensemble to those obtained by other unsupervised anomaly-detection models and report the ensemble as having a high performance if its performance is better than the other anomaly-detection models that we benchmark. This method is not a valid evaluation method as it is not representative of the true setting in which the Accurately-Diverse ensemble will be applied: specifically, when the analyst performs the model selection process in the unsupervised setting she has no way of knowing which model out of the N candidate models performs the best. Thus, even if one of the N models, m′, performs better than the Accurately-Diverse ensemble, this does not imply that the ensemble is inferior to m′ since m′ will probably not be chosen as the model to be applied. In fact, under our no-prior-knowledge assumption, it will be chosen only with a probability of 1/N; moreover, the best-performing model out of the N models has the exact same probability of being chosen as the worst-performing model.

In order for the evaluation results to be representative of the true unsupervised setting in which our ensemble will be applied we compare our results to those of the average anomaly-detection model, to which we refer as the average single model. Assuming that we are given the option to choose a model out of N candidate unsupervised anomaly-detection models, the average single model can be evaluated in two ways:
1. Average Score (AS): evaluate the performance of each one of the N candidate models using a supervised evaluation metric. Then average the results.
2. Randomly-Sampled Prediction Score (RSPS): given the predictions of each of the N candidate models and an observation, i, we randomly sample one of the N predictions of i; by repeating this process for every observation, we form a new, randomly-sampled list of predictions. We then use a supervised metric to evaluate the performance of that list.

The idea behind each of those two procedures for evaluating the average single model is simulating the real-world, unsupervised use case in which our ensemble will be applied and in which, given N candidate models, the analyst's choice of model is practically random.

Table 1 compares our ensemble model results with the results of the average single model, using AS and RSPS, over different datasets. For each dataset, given a pool of unsupervised models, we first build an Accurately-Diverse ensemble of size M, where, in our experiments, 3<M<5. We train the ensemble on the dataset and then use it to form predictions by aggregating the individual predictions of the ensemble members. After experimenting with multiple aggregation methods we found the arithmetic mean to perform best. We then re-rank the aggregated predictions and use the result as the final output of the ensemble. Our pool of models is composed of 15<N<25 of the most commonly used unsupervised anomaly-detection models; specifically, we followed [10] and used most of the models that they used, with the addition of some newer methods such as [9, 19, 32].

The results of the average top Accurately-Diverse ensemble and the average bottom-Accurately-Diverse ensemble for each dataset are shown in Table 1 and are compared against the results of the average single model approximated using the AS and RSPS. For evaluation purposes, we use prec@n scores and PR AUC scores. The heuristic

TABLE 2
Spearman correlation between the average [symbol] score
and multiple supervised evaluation metrics

| Dataset | prec@n | PR AUC | [20] PR AUC |
|---|---|---|---|
| smtp | .87 | .88 | .61 |
| backdoor | .86 | .9 | .65 |
| satellite | .87 | .91 | .76 |
| magic. gamma | .91 | .93 | .73 |
| fraud | .86 | .82 | .58 |
| campaign | .85 | .93 | .68 |
| mnist | .92 | .94 | .78 |

that we used in order to choose the top Accurately-Diverse ensembles is the following: we first sort the ensembles by the degree of their fuzzy rank correlation; then, out of the top-ranked ensembles in terms of fuzzy rank correlation, we choose those with the lowest exact rank index correlation.

As shown in Table 1, the top ensemble consistently outperforms the average single model using both the AS and RSPS. In addition, there is a significant difference in performance between the top Accurately-Diverse model and the bottom Accurately-Diverse model. The results support claim 1 (see Section “Claims”), according to which an Accurately-Diverse ensemble yields better results than the average anomaly-detection model. Thus, the process of creating an Accurately Diverse ensemble can be seen as the equivalent of a model-selection procedure in the unsupervised setting where no labeled data is available, and using the Accurately-Diverse ensemble as the main model for the anomaly-detection task at hand practically eliminates the need for a single-model-selection procedure.

Table 2 shows the Spearman rank correlation results between the [symbol] score and an array of supervised evaluation metrics. Specifically, for each dataset, we used the top-Accurately-Diverse ensembles to evaluate the performance of each of the N candidate models that were not chosen to be part of the ensemble in an unsupervised manner, thus forming a vector of unsupervised evaluation results. We also evaluated the performance of the N models using 2 supervised evaluation metrics: prec@n and PR AUC resulting in 2 vectors of supervised evaluation results. We then computed the Spearman correlation coefficient between the average unsupervised-evaluation-results vector and each of the supervised-evaluation-results vectors.

The results demonstrate a very high correlation between the [symbol] score and the PR AUC and prec@n scores. The results support claim 2 (see Section “Claims”), according to which an Accurately-Diverse ensemble can be used to evaluate the results of other anomaly-detection models, yielding results that are on par with supervised evaluation metrics. Finally, we have attempted to run the methods in [6, 20], the only two unsupervised evaluation methods that we are aware of. As seen in Table 2, the results obtained using the method described in are significantly lower than ours. The method described in [6], which we implemented using [7], had an extremely low correlation on all the supervised correlation metrics listed in Table 2, results that ranged from 0 to 0.6; on most datasets, the results were low to the point of a non-existent correlation.

1. In unsupervised anomaly-detection settings where a supervised model-selection procedure—a procedure that compares the performance of N candidate anomaly-detection models on a given dataset—cannot be performed due to the lack of labeled data, an Accurately Diverse ensemble will yield better results than the average anomaly-detection model thus eliminating the need for a model-selection procedure.

2. In unsupervised anomaly-detection settings, where the only model that can be used is a single model rather than an ensemble (for instance, due to regulatory requirements) yet due to the lack of a labeled validation set a supervised evaluation of the model cannot be performed, an Accurately-Diverse ensemble can be used to evaluate the model's predictions in an unsupervised manner, yielding results that are on par with those of supervised evaluation metrics.
